(19) United States
(12) Patent Application Publication
(10) Pub. No.: US 2012/0257114 A1
(43) Pub. Date: Oct. 11, 2012

(54) DISTRIBUTION APPARATUS AND VIDEO DISTRIBUTION METHOD

(75) Inventor: Tadashi Eguchi, Tokyo (JP)

(73) Assignee: CANON KABUSHIKI KAISHA, Tokyo (JP)

(21) Appl. No.: 13/435,866

(22) Filed: Mar. 30, 2012

(30) Foreign Application Priority Data
Apr. 7, 2011 (JP) 2011-085651

(51) Int. Cl. H04N 9/67

(52) U.S. Cl. 348/659; 348/E09.047

(57) ABSTRACT

A distribution apparatus in a video display system for combining and displaying at least two video images transmitted via multiple communication paths decides the qualities of each of the video images combined and displayed based upon the transmission rates of the multiple communication paths. The apparatus distributes video images via each of the communication paths in accordance with the transmission rates of each of the communication paths and the qualities of each of the video images.

### BACKGROUND OF THE INVENTION

1. Field of the Invention

The present invention relates to a technique for transmitting video data to multiple video output devices via multiple communication paths between multiple wireless transmitters and multiple wireless receivers.

2. Description of the Related Art

There is a system which projects split video using multiple projectors, combines the projected images and displays large-screen video, and a system which superimposes and displays a plurality of images from projectors the luminance of which is inadequate. There is also a system which displays 3D video by superimposing left and right images. Thus, there are various multiprojection systems for displaying a large picture as multiple images.

The video in such a large-picture multiprojection system is required to have a high image quality, and the amount of video data involved is enormous. In addition, the enlargement in screen size is accompanied by a longer distance between the projector and the video source and by more complicated wiring. As a consequence, the desire to adopt a wireless scheme for such a system has become very great.

Wireless communication systems involve larger capacity, as in MIMO techniques and milliwave transmission. However, in order to transmit large pictures and high-quality video that has not been compressed to a plurality of projectors, communication on multiple channels using multiple wireless communication devices is required.

For example, the specification of Japanese Patent Laid-Open No. 06-268985 discloses a technique for transmitting multiple items of video data using multiple channels. This technique varies the transmission rate per image channel in accordance with amount of information generated per image channel within the total transmission rate of the multiple transmission channels. Further, data on an image channel allocated in excess of the transmission rate of a single channel is transmitted utilizing a transmission channel that corresponds to an adjacent image channel.

In a multiprojection system for sending and receiving multiple items of video data by multiple wireless transmitters, there are instances where the required transmission rate cannot be maintained when the propagation environment changes owing to obstacles that block the electromagnetic waves of wireless communication, electric-wave interference ascribable to other communication devices, and the like. If the transmission rate of one communication path declines, the video transmitted via this communication path is disturbed. In the case of large-screen video, the seam or boundary between disturbed video and undisturbed video becomes conspicuous and the overall video quality deteriorates.

Further, in the case of 3D video or a case where video is superimposed in order to improve luminance, if high-quality video and low-quality video are superimposed, there are instances where image disturbance caused by the low-quality video becomes prominent and a decline in overall video image quality becomes conspicuous.

### SUMMARY OF THE INVENTION

The present invention provides an apparatus and method adapted so that even if the transmission rate of any communication path of multiple communication paths declines, the video images combined and displayed are uniformalized in image quality.

According to one aspect of the present invention, there is provided a distribution apparatus in a video display system for combining and displaying at least two video images transmitted via multiple communication paths, comprising: a first deciding device configured to decide qualities of each of the video images combined and displayed based upon transmission rates of the multiple communication paths; a second deciding device configured to decide distribution ratios of multiple video images, which are transmitted via the multiple communication paths, in accordance with the transmission rates of the multiple communication paths and qualities of each of the video images decided by the first deciding device; and a distributing device configured to distribute multiple video images to the multiple communication paths in accordance with the distribution ratios decided by the second deciding device.

Further features of the present invention will become apparent from the following description of exemplary embodiments (with reference to the attached drawings).

### BRIEF DESCRIPTION OF THE DRAWINGS

FIGS. 1A and 1B are diagrams illustrating an example of the configuration of a video transmission system according to a first embodiment of the present invention;

FIG. 2 is a flowchart illustrating overall processing in the first embodiment;

FIG. 3 is a flowchart illustrating processing for changing over communication paths (wireless transmission paths);

FIGS. 4A and 4B are diagrams illustrating examples of packet structures;

FIGS. 5A and 5B are block diagrams illustrating examples of a first modification;

FIGS. 6A and 6B are block diagrams illustrating examples of a first modification;

FIGS. 7A and 7B are diagrams illustrating an example of the configuration of a video transmission system according to a second embodiment of the present invention; and

FIG. 8 is a flowchart illustrating overall processing in the second embodiment.

### DESCRIPTION OF THE EMBODIMENTS

Embodiments of the present invention will be described below with reference to the drawings. Described in the embodiments are a distribution apparatus and video distribution method in a video display system for combining and displaying at least two video images transmitted via multiple communication paths.

It should be noted that although a case where a first communication path and a second communication path are the multiple communication paths will be described, the present invention is not limited to such case. Further, although a case where a first video image and a second video image are distributed is described, the present invention is not limited to such case.

### First Embodiment

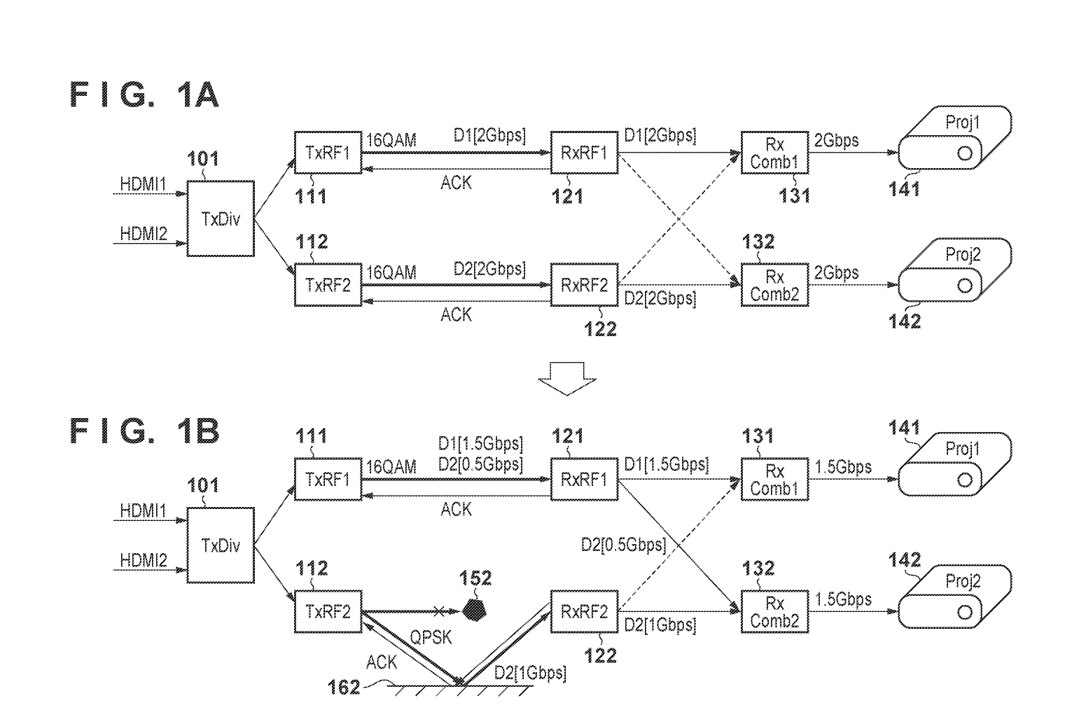

FIG. 1A is a diagram illustrating a normal transmission state. FIG. 1B, on the other hand, is a diagram illustrating operation in a case where a wireless communication path from a wireless transmitter (TxRF) to a wireless receiver (RxRF) is obstructed by an obstacle and the amount of data transmission is reduced owing to use of a reflection path constituted by a wall. In the description that follows, the wireless transmitter and wireless receiver will be referred to simply as a transmitter and receiver, respectively.

This embodiment will be described taking as an example a system in which a projector 141 projects the right-half side of video of a large screen, a projector 142 projects the left-half side of video of the large screen and these left and right video images are joined together to thereby project large-screen video. However, the present invention is applicable even in a system that superimposes the video images from the projectors 141 and 142 to thereby improve the luminance of the projected video and in a system in which the projectors 141 and 142 project left and right video images of 3D video and superimpose these video images to display video rendered in 3D.

A data distributor (TxDiv) 101 shown in FIGS. 1A and 1B receives input of items of video data that are the result of dividing a single item of video data into left-side video (HDMI1) and right-side video (HDMI2), and distributes this video data to multiple video output devices (the projectors) 141 and 142. Transmitters 111 and 112 wirelessly transmit the respective items of video data, and receivers 121 and 122 receive the respective items of video data. Data combiners 131 and 132 are each connected by wire to both of the receivers 121 and 122. Here an arrangement is described in which the inputs to the data distributor 101 are the left-side video (HDMI1) and right-side video (HDMI2). However, it may be arranged so that the data distributor 101 splits a single video image into left-side video and right-side video.

Assume that best-quality video can be obtained from the projectors 141 and 142 if the video is transmitted via communication paths having a transmission rate of 2 Gbps. Accordingly, if communication is being achieved at a transmission rate of 2 Gbps on each of the communication paths between the transmitter 111 and receiver 121 and between the transmitter 112 and receiver 122, as shown in FIG. 1A, then the video projected from the projectors 141 and 142 will be of the best quality. The data distributor 101 distributes only the video data of projector 141 to the transmitter 111 and distributes only the video data of projector 142 to the transmitter 112. The header of the video data applied to the transmitter 111 has contents indicating that the destination of all of this video data is the projector 141. Similarly, the header of the video data applied to the transmitter 112 has contents indicating that the destination of all of this video data is the projector 142.

The receiver 121 is connected by wire to both of the data combiners 131 and 132. However, in accordance with the contents of the header received, the receiver 121 sends video data only to the data combiner 131 and all of the video data is sent from the data combiner 131 to the projector 141. The receiver 122 also is connected by wire to both of the data combiners 131 and 132. However, in accordance with the contents of the header received, the receiver 122 sends video data only to the data combiner 132 and all of the video data is sent from the data combiner 132 to the projector 142.

In FIG. 1B, communication can be achieved at the best-quality transmission rate of 2 Gbps on the communication path between the transmitter 111 and the receiver 121. On the other hand, communication can be achieved only at a transmission rate of 1 Gbps on the communication path between the transmitter 112 and the receiver 122. Accordingly, the data distributor 101 decides video-data quality in such a manner that communication will be performed at a transmission rate of 3 Gbps in total and decides the distribution of video data transmitted on each of the communication paths. In other words, the data distributor 101 decides video quality in such a manner that video will be transmitted to each of the projectors 141 and 142 at a transmission rate of 1.5 Gbps and adjusts the quality of the entered video. The adjustment of video quality is carried out by adjusting the bit width of resolution or gradation of the video. However, it is also permissible to adjust the video compression rate, adjust the frame rate, adjust both of these or apply adjustment by some other method.

Of the 2-Gbps transmission rate on the communication path between the transmitter 111 and receiver 121, the data distributor 101 allocates 1.5 Gbps to the video data destined for the projector 141 and allocates 0.5 Gbps to the video data destined for the projector 142. The data distributor 101 distributes to the transmitter 111 the video data transmitted at these transmission rates. Further, the data distributor 101 allocates the total of the 1-Gbps transmission rate on the communication path between the transmitter 112 and receiver 122 to the video data of projector 142 and distributes to the transmitter 112 the video data transmitted at 1 Gbps. Of the 1.5-Gbps video data transmitted to the projector 142, it will suffice if the data distributor 101 distributes a packet of 0.5 Gbps to the transmitter 111 and distributes a packet of 1.0 Gbps to the transmitter 112.

The header of the video data applied to the transmitter 111 has contents indicating that the destination of the 1.5-Gbps video data is the projector 141 and that the destination of the 0.5-Gbps video data is the projector 142. On the other hand, the header of the video data applied to the transmitter 112 has contents indicating that the destination of all of this video data is the projector 142.

In accordance with the contents of the header received, the receiver 121 sends the data combiner 131 the video data destined for the projector 141 that has been transmitted at the 1.5-Gbps transmission rate. Furthermore, the receiver 121 sends the data combiner 132 the video data destined for the projector 142 that has been transmitted at the 0.5-Gbps transmission rate. As a result, the data combiner 131 transmits to the projector 141 the video data that has been transmitted at the 1.5-Gbps transmission rate. In accordance with the contents of the header received, the receiver 122 transmits the video data destined for the projector 142, which data has been transmitted at the 1-Gbps transmission rate, only to the data combiner 132. This video data is combined with the 0.5-Gbps video data, which has been transmitted from the receiver 121, by the data combiner 132 and the resultant 1.5-Gbps video data is transmitted to the projector 142.

Thus, as described above, the quality of the video data transmitted to multiple projectors is evened out, thereby uniformalizing the left-and-right video outputs and making it possible to render inconspicuous the boundary between the video images.

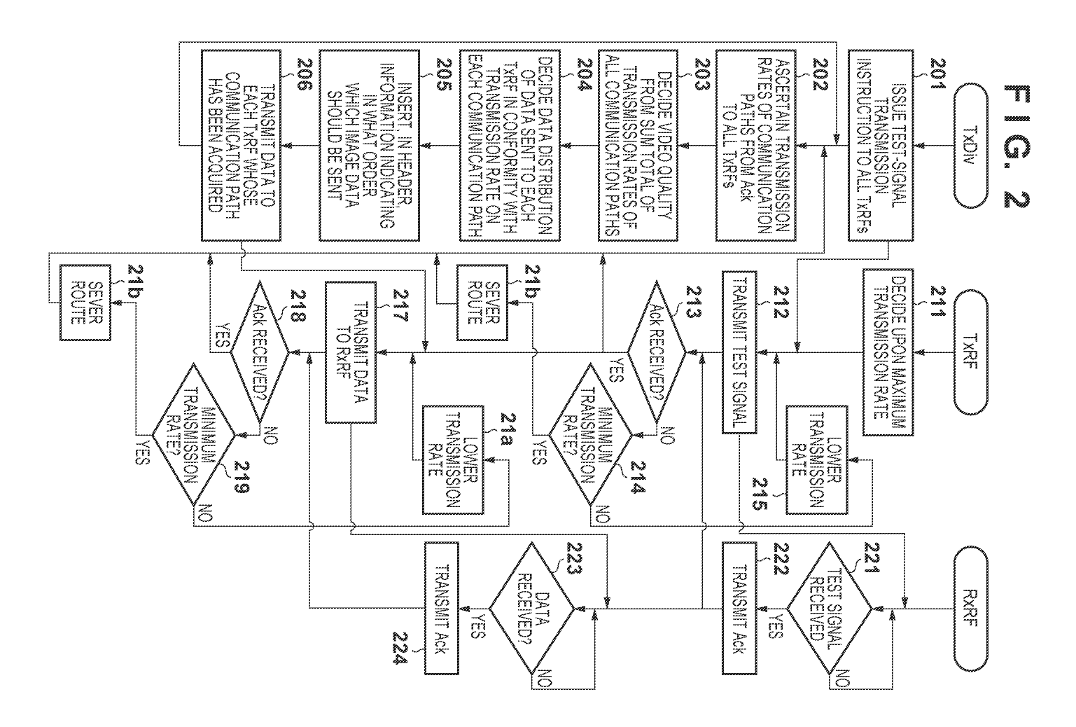

Reference will now be had to FIG. 2 to describe overall processing executed by the data distributor, transmitters and receivers in the first embodiment. First, in order to investigate the initial states of the multiple communication paths, the data distributor issues a test-signal transmission instruction that causes all of the connected transmitters to transmit test signals to all of the receivers (step 201). Next, the transmission rates of the respective communication paths are ascertained from an acknowledgement (Ack) sent back from all of the receivers (step 202). It should be noted that, in the example shown in FIGS. 1A and 1B, there are two transmitters and two receivers. However, since the necessary number of communication paths varies depending upon the size of the video screen, the manner in which video is divided and the transmission rate, etc., the number of transmitters and receivers is not limited to two.

Next, the data distributor calculates the sum total of the transmission rates of all of the communication paths and decides video quality based upon the amount of data capable of being transmitted at the sum-total transmission rate (step 203). Further, the data distributor adjusts the quality of the video transmitted to each projector so as to uniformalize the image qualities of the video transmitted to each of the projectors, thereby deciding the amount of video data transmitted to each projector. Then, in conformity with the transmission rate on each communication path, the data distributor decides the data distribution of the multiple items of video data transmitted from each of the transmitters (step 204). Next, the data distributor inserts a header into the video data sent to each transmitter (step 205). It should be noted that the header contains information such as video-data destination, amount, order and transmission rate decided in accordance with the data distribution.

Next, the data distributor sends the data, into which the header has been inserted, to all of the transmitters with the exception of transmitters for which communication paths have not been acquired (step 206). The data distributor thenceforth returns to processing for ascertaining the transmission rates of the communication paths and ascertains the transmission rate of each communication path from the acknowledgement (Ack) response to the video data transmitted by each transmitter.

Further, in the initial state, the maximum transmission rate has been set in each transmitter (step 211). Upon receiving the test-signal transmission instruction from the data distributor, the transmitter transmits the test signal to the receiver (step 212). After transmitting the test signal, the transmitter waits for receipt of acknowledgement (Ack) from the receiver (step 213) and determines whether the transmission rate is the minimum rate if acknowledgement (Ack) cannot be received (step 214). If the result of the determination is that the transmission rate is not the minimum rate, then the transmitter lowers the transmission rate (step 21a) and returns to processing for transmitting the test signal to the receiver. Even if the transmission rate is the minimum rate, this transmission route is severed in a case where the acknowledgement (Ack) cannot be received (step 21b). In a case where the acknowledgement (Ack) can be received, on the other hand, the transmitter preserves the transmission rate prevailing at this time and conveys the transmission rate to the data distributor.

At the time of the data transfer that follows, the transmitter transmits the data at the transmission rate for which test-signal acknowledgement could be received (step 217). The transmitter then waits for receipt of acknowledgement (step 218) and, when acknowledgement cannot be received, the transmitter determines whether the transmission rate is the minimum transmission rate in a manner similar to transmission of the test signal (step 219). If the result of the determination is that the transmission rate is not the minimum rate, then the transmitter lowers the transmission rate (step 21a). Even if the transmission rate is the minimum rate, this transmission route is severed in a case where acknowledgement cannot be received (step 21b).

Further, each receiver receives the test signal or data from the transmitter (steps 221, 223) and transmits acknowledgement if the test signal or data could be received (steps 222, 224).

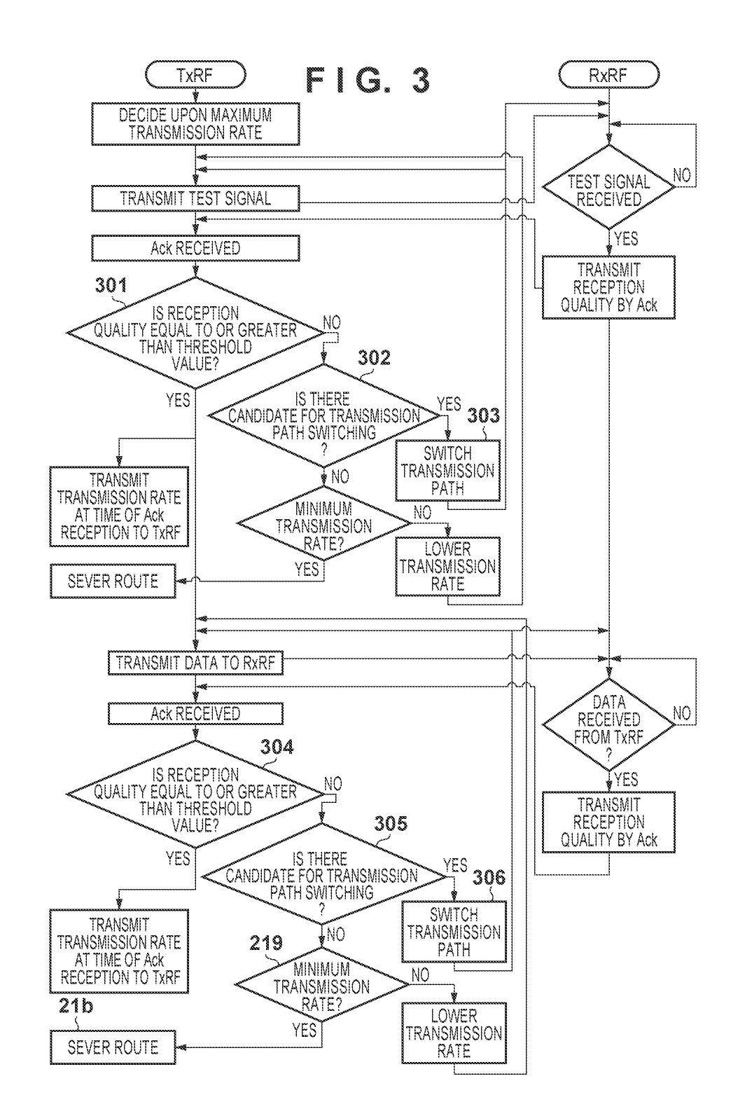

Next, reference will be had to FIG. 3 to describe the processing executed by the transmitters and receivers in a case where operation is accompanied by switching of communication paths (wireless transmission paths). The processing executed by the data distributor shown in FIG. 2 is omitted since there is no change except for the fact that operation is accompanied by switching of the wireless transmission paths between the transmitters and receivers.

FIG. 3 differs from the processing shown in FIG. 2 in that the following processing steps are added to the processing of FIG. 2: The transmitter determines whether the reception quality contained in the acknowledgement response of the receiver is equal to or greater than a predetermined threshold value (steps 301, 304) and, in a case where the reception quality is not equal to or greater than the threshold value, switches to a wireless transmission path for which the reception quality is equal to or greater than the same threshold value (steps 303, 306) if such a wireless transmission path exists (steps 302, 305). Thus, it is possible to transmit data on the optimum transmission path and at the maximum transmission rate by two loops for switching the wireless transmission path and for lowering the transmission rate.

Thus, the data distributor 101 adjusts the bit width of resolution or gradation in accordance with the sum total of the transmission rates of all communication paths. Furthermore, the data distributor 101 adjusts the video quality and amount of data of the video data to each projector transmitted via each communication path and substantially equalizes the video qualities that are output from each of the projectors. The data distributor 101 subdivides the video data into the respective wireless packet sizes and sends the packets to the transmitters 111 and 112. When the video data is subdivided into packet sizes, the data distributor 101 decides the transmission rate on each communication path, the ratios of the video data transmitted on the respective communication paths and the packet size of each item of video data in such a manner that the video of the multiple projectors 141 and 142 will be uniformalized in image quality.

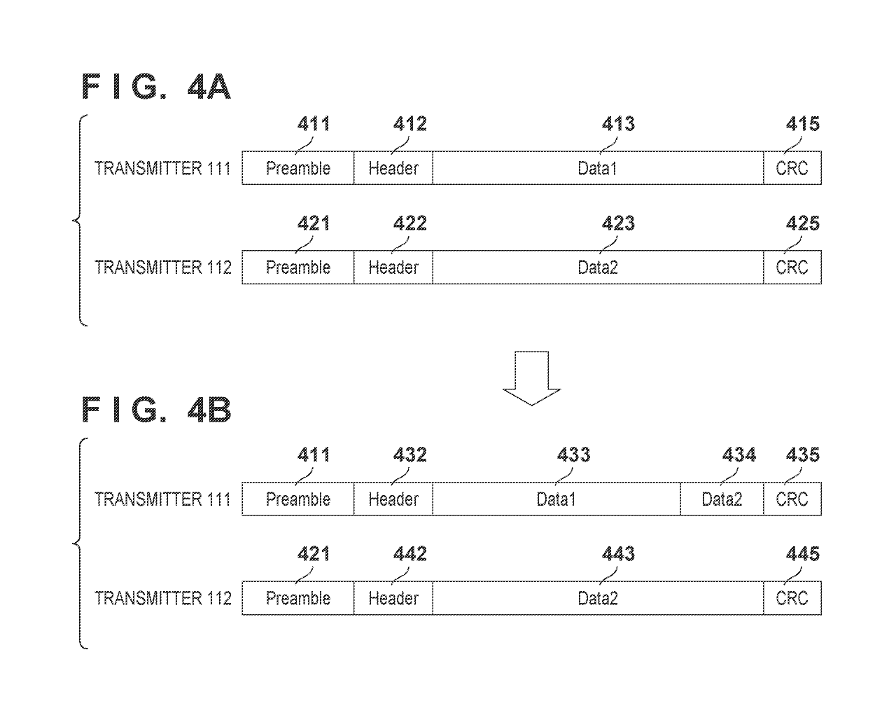

Examples of the packet structures of the transmitters 111 and 112 shown in FIGS. 1A and 1B are illustrated in FIGS. 4A and 4B. FIG. 4A is a diagram illustrating the structure of packets transmitted from the transmitters 111 and 112 in FIG. 1A. The packets are composed of preambles 411, 421, headers 412, 422, data sections 413, 423 and CRCs (Cyclic Redundancy Checks) 415, 425. In a case where video data is transmitted, it is necessary to transmit, in addition to the packet that transmits the video data, the required data in a period of time that includes Ack reception time (not shown) and waiting time up to the preamble for the next item of video data. Accordingly, in the case of a communication path on which video data is transmitted at a throughput of 2 Gbps, the transmission rates in the data sections 413 and 423 are greater than 2 Gbps. The headers 412 and 422 contain information such as the transmission rates of the data sections 413 and 423 or the modulation scheme (16 QAM in the case of FIGS. 1A and 1B) of these transmission rates, the encoding rates and data lengths, etc. The throughput of 2 Gbps of the video data of projectors 141, 142 is implemented from these items of information.

FIG. 4B is a diagram illustrating the structure of packets transmitted from the transmitters 111 and 112 in FIG. 1B. The structure of these packets is similar to that of FIG. 4A. However, the header 432 of transmitter 111 in FIG. 4B contains information such as the modulation scheme and encoding rate, the positions and lengths of the data sections 433, 434, and information indicating which portion of the data for the projector 142 the data section 434 is intended. The header 442 of the transmitter 112 contains information such as the modulation scheme (QPSK in the case of FIGS. 1A and 1B) and encoding rate after the transmission rate is lowered, and information indicating which portion of the data is for the projector 142.

It should be noted that FIGS. 4A and 4B illustrate one example of a method of performing data sharing at the length of the data in the packets. However, it is permissible to implement a different method of data sharing, such as using a subcarrier of OFDM modulation.

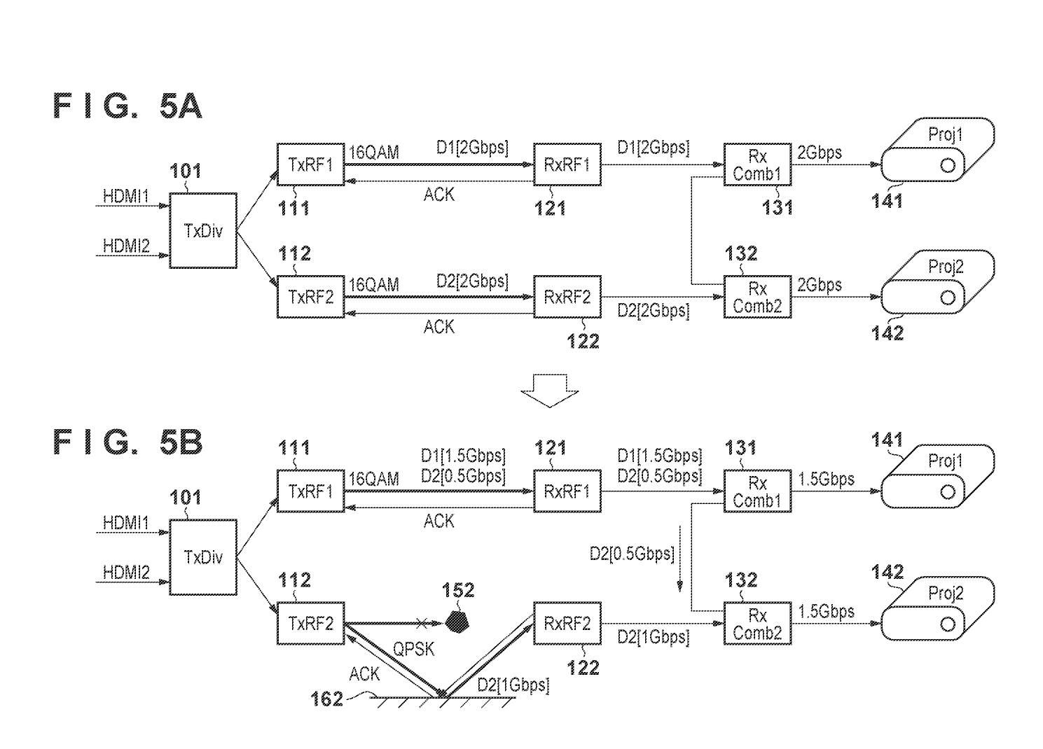

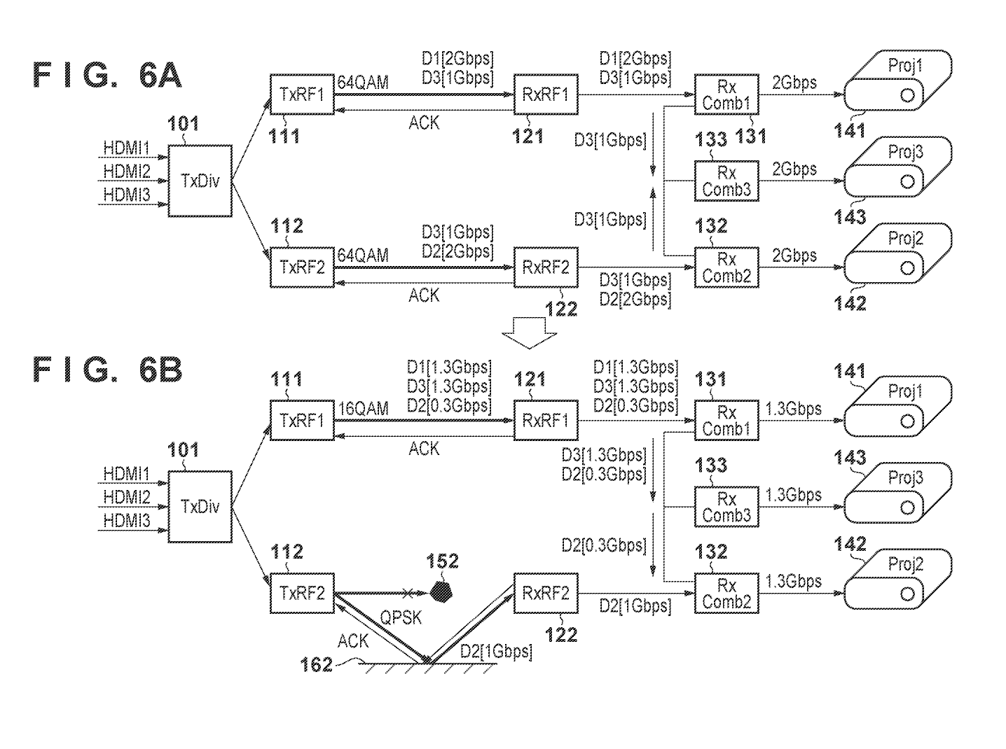

A modification of the first embodiment will be described with reference to FIGS. 5A, 5B, 6A and 6B. FIGS. 5A and 5B are block diagrams illustrating examples of a first modification. In the first modification, the receivers 121 and 122 are connected to the data combiners 131 and 132, respectively, and the data combiners 131 and 132 are connected by wire so as to be capable of transmitting data bidirectionally. The data combiner 131 transmits video data to the projector 141 or to the data combiner 132 in accordance with the contents of the header of the video data received. Similarly, the data combiner 132 transmits video data to the projector 142 or to the data combiner 131 in accordance with the contents of the header of the video data received. In the example of FIG. 5B, the data combiner 131 sends the projector 141 the 1.5-Gbps video data, which is destined for the projector 141, from the received video data. Further, the data combiner 132 sends the data combiner 132 the 0.5-Gbps video data, which is destined for the projector 142, from the received video data. The data combiner 132 combines the 0.5-Gbps video data received from the data combiner 131 and 1-Gbps video data received from the receiver 122 and transmits the result to the projector 142. This arrangement is effective in a case where the numbers of receivers and data combiners are large and in a case where there is a long distance between a receiver and a data combiner.

FIGS. 6A and 6B are block diagrams illustrating examples of a second modification. In the second modification, the transmitter 111 and receiver 121, as well as the transmitter 112 and receiver 122, are capable of communicating by 64 QAM, and each wireless communication path has a data transmission rate equivalent to 3 Gbps. On the other hand, it will suffice if each of the projectors 141, 142 and 143 has a throughput of 2 Gbps. The data for the three projectors can be transmitted on two wireless communication paths. The arrangement of FIG. 6A transmits 2-Gbps data for projector 141 and 1-Gbps for projector 143 between the transmitter 111 and receiver 121, and transmits 2-Gbps data for projector 142 and 1-Gbps for projector 143 between the transmitter 112 and receiver 122. Accordingly, the data combiners 131 and 132 transmit the 1-Gbps data portions for projector 143 to a data combiner 133 on a wired path. The data combiner 133 combines these items of video data and transmits the result to the projector 143.

When, in FIG. 6B, the transmission rate becomes 1 Gbps between the transmitter 112 and receiver 122, the video data for the projectors 141, 143 and 142 is transmitted at 1.3, 1.3 and 0.3 Gbps, respectively, between the transmitter 111 and receiver 121. On the other hand, only 1-Gbps data for the projector 142 is transmitted between the transmitter 112 and receiver 122. The data combiner 131 separates the data for the respective projectors and transmits the video data for projectors 143, 142 on a wired path. The data combiner 133 selects and separates only the video data for projector 143 from the video data for projectors 143, 142 and transmits this data to the projector 143. Further, the data combiner 132 selects and separates only the video data for projector 142 from the video data for projectors 143, 142, combines this data with the video data received by the receiver 122 and transmits the resultant video data to the projector 142.

Described above in the first embodiment are a case where the number of projectors and the number of wireless communication paths agree and a case where the number of projectors is greater than the number of wireless communication paths. However, this does not impose any limitation and it is permissible for the number of wireless communication paths to be greater than the number of projectors.

Thus, in accordance with this embodiment, the qualities of video that is output from each of the video output devices can be substantially equalized and uniformalized even if the transmission rates on some communication paths decline. Further, since video quality is decided based upon the transmission rates of all multiple communication paths and video transmitted on each communication path is decided, communication paths can be utilized efficiently and the quality of output video can be improved. For example, in a case where video images output from each of the video output devices are joined together to provide a large-screen image, the conspicuousness of the boundary due to the qualities of each of the images can be reduced. Further, a decline in overall video quality can be suppressed in a case where the video images output from each of the video output devices are superimposed to improve luminance and provide 3D video.

### Second Embodiment

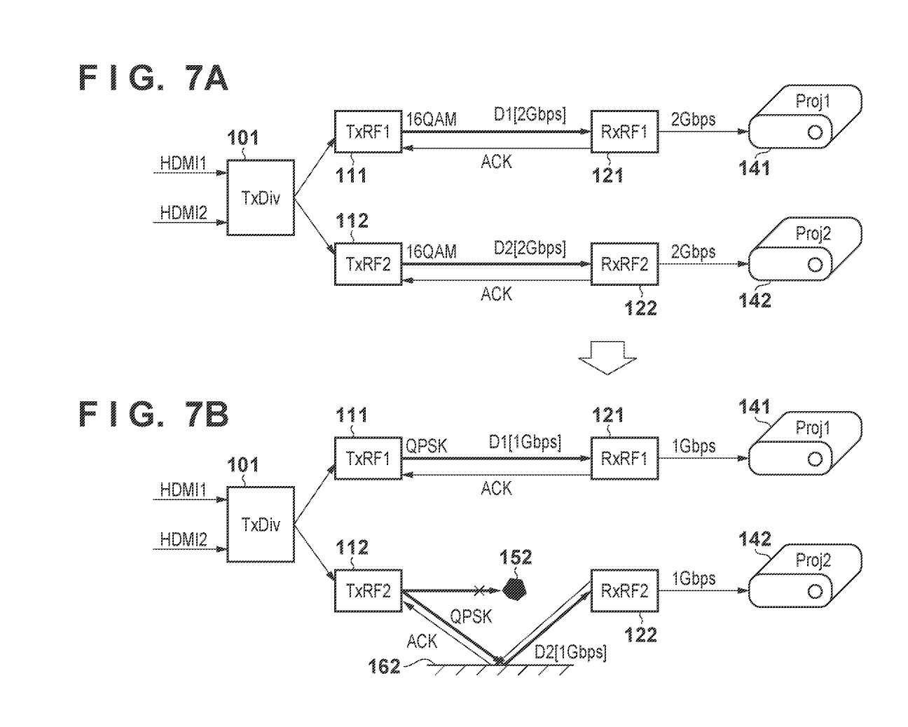

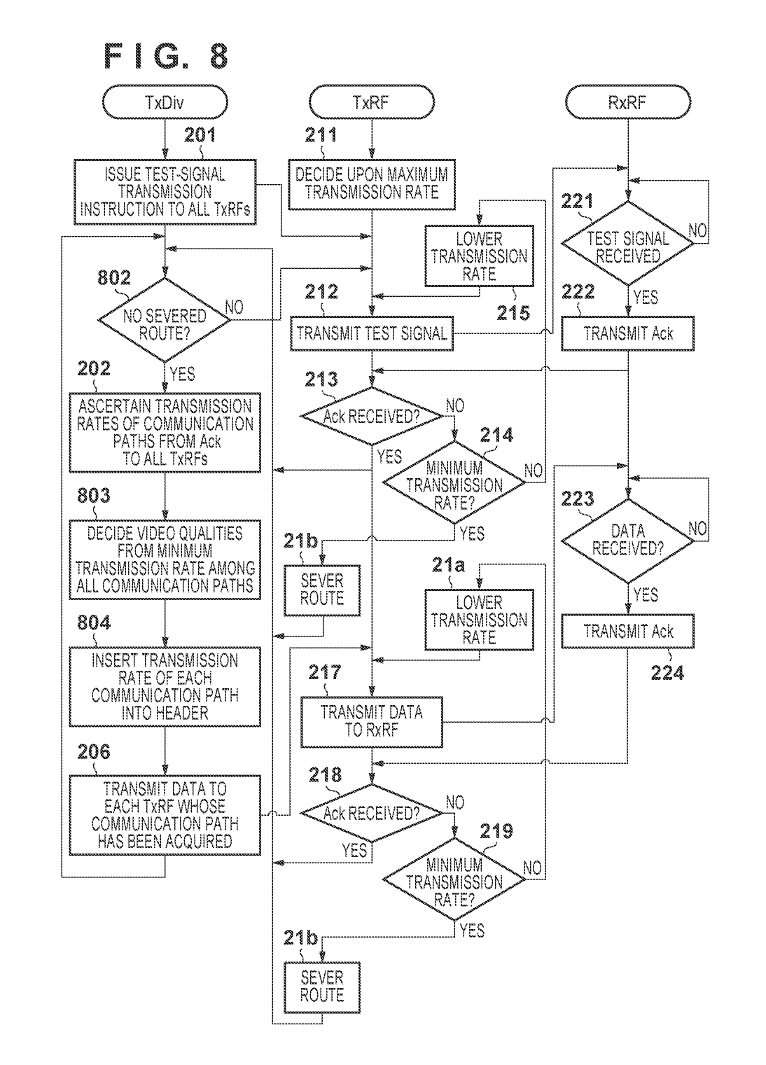

Next, reference will be had to FIGS. 7A, 7B and 8 to describe a second embodiment of the present invention in detail. It should be noted that components shown in FIGS. 7A and 7B are identified by the same reference characters used to identify like components in the first embodiment shown in FIGS. 1A and 1B.

In the second embodiment, the transmitter 111 and receiver 121 have been inserted for the purpose of substituting a data transmission line between the data distributor 101 and the projector 141. Further, the transmitter 112 and receiver 122 also have been inserted for the purpose of substituting a data transmission line between the data distributor 101 and the projector 142.

In this arrangement, the data distributor 101 distributes video data so that the projectors 141, 142 will have the same image quality. Further, as shown in FIG. 7B, in a case where the communication path between the transmitter 112 and receiver 122 is obstructed by an obstacle 152 and the transmission rate declines owing to a reflection path, the transmission rate on the communication path between the transmitter 111 and receiver 121 also is lowered in conformity with the path of reduced transmission rate. As a result, the throughputs to the projectors 141 and 142 are equalized and image qualities are uniformalized. This means that the boundary between images will not become conspicuous owing to a decline in the image quality of one of the images.

FIG. 8 is a flowchart illustrating the overall processing executed by the data distributor, transmitters and receivers in the second embodiment. The operation of the transmitters and receivers in FIG. 8 is similar to that of FIG. 2.

In order to investigate the initial states of the communication paths, the data distributor issues a test-signal transmission instruction that causes all of the connected transmitters to transmit test signals to all of the receivers (step 201). Next, in the second embodiment, the data distributor confirms that there are no severed routes in order to make all communication paths conform to the communication path of the minimum transmission rate (step 802). In a case where a severed communication path exists, the data distributor causes the transmission of the test signal to the transmitter of this path until the communication path is established. When there is no longer a severed route, the transmission rate of each communication path is ascertained from acknowledgement (Ack) received by all of the transmitters (step 202). It should be noted that, in the example described in FIG. 8, there are two transmitters and two receivers. However, since the necessary number of communication paths varies depending upon the size of the video screen, the manner in which video is divided and the transmission rate, etc., the number of transmitters and receivers is not limited to two.

Next, when the respective transmission rates are ascertained from the acknowledgement (Ack) of all transmitters, the data distributor decides the video qualities of the projectors in conformity with the minimum transmission rate (step 803). The data distributor then inserts a header in front of the data sent to each transmitter (step 804). The header contains information such as the transmission rate decided. Next, the data distributor sends the video data, into which the header has been inserted, to each transmitter (step 206). The data distributor thenceforth returns to processing for determining whether there is no severed route and ascertains the transmission rate of each communication path from the acknowledgement (Ack) response to the video data transmitted by each transmitter.

Thus, the qualities of the video output from multiple video output devices can be uniformalized to conform with the transmission rates in a system in which multiple items of video data are transmitted by multiple wireless communication devices and the multiple items of video data are combined using multiple video output devices to display a single video image.

Further, although various methods of changing video throughput are conceivable, such as changing the size of the smallest pixel of video or changing the resolution of gradations of color, the manner in which video throughput is changed is outside the scope of application of the present invention.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-085651, filed Apr. 7, 2011, which is hereby incorporated by reference herein in its entirety.

What is claimed is:

1. A distribution apparatus in a video display system for combining and displaying at least two video images transmitted via multiple communication paths, comprising:
a first deciding device configured to decide qualities of each of the video images combined and displayed based upon transmission rates of the multiple communication paths;
a second deciding device configured to decide distribution ratios of multiple video images, which are transmitted via the multiple communication paths, in accordance with the transmission rates of the multiple communication paths and qualities of each of the video images decided by said first deciding device; and
a distributing device configured to distribute multiple video images to the multiple communication paths in accordance with the distribution ratios decided by said second deciding device.

2. The apparatus according to claim 1, wherein said first deciding device again decides the qualities of each of the video images, which are transmitted via the multiple communication paths, in accordance with a change in transmission rates on some communication paths of the plurality of communication paths; and
said second deciding device again decides the distribution ratios of multiple video images, which are transmitted via the multiple communication paths, in accordance with the transmission rates of the multiple communication paths and the qualities of each of the video images decided again by said first deciding device.

3. The apparatus according to claim 1, wherein said first deciding device decides the qualities of each of the video images in such a manner that the qualities of each of the video images are uniformalized.

4. The apparatus according to claim 1, further comprising an adding device configured to add information, which indicates a video output unit at a destination, to each of the video images transmitted via the multiple communication paths.

5. The apparatus according to claim 1, wherein in a case where a transmission rate of a first communication path of the multiple communication paths is greater than a transmission rate of a second communication path, said distributing device distributes portions of the first and second video images among the multiple video images to the first communication path.

6. The apparatus according to claim 1, wherein said first deciding device decides the qualities of each of the video images based upon a communication path having a minimum transmission rate.

7. The apparatus according to claim 1, further comprising a display device configured to combine and display video images received via the multiple communication paths.

8. A distribution apparatus in a video display system for combining and displaying at least two video images transmitted via multiple communication paths, comprising:
a deciding device configured to decide qualities of each of the video images combined and displayed based upon transmission rates of the multiple communication paths;
a changing device configured to decide distribution ratios of multiple video images, which are transmitted via the multiple communication paths, in accordance with the transmission rates of the multiple communication paths and qualities of each of the video images decided by said deciding device; and
a distributing device configured to distribute multiple video images to the multiple communication paths in accordance with the distribution ratios changed by said second changing device.

9. A method of controlling a distribution apparatus in a video display system for combining and displaying at least two video images transmitted via multiple communication paths, comprising:
deciding qualities of each of the video images combined and displayed based upon transmission rates of the multiple communication paths;
deciding distribution ratios of multiple video images, which are transmitted via the multiple communication paths, in accordance with the transmission rates of the multiple communication paths and qualities of each of the video images decided; and
distributing multiple video images to the multiple communication paths in accordance with the distribution ratios decided.

10. A non-transitory computer-readable recording medium storing a program for causing a computer to execute a method of controlling a distribution apparatus in a video display system for combining and displaying at least two video images transmitted via multiple communication paths, the method comprising:
deciding qualities of each of the video images combined and displayed based upon transmission rates of the multiple communication paths;
deciding distribution ratios of multiple video images, which are transmitted via the multiple communication paths, in accordance with the transmission rates of the multiple communication paths and qualities of each of the video images decided; and
distributing multiple video images to the multiple communication paths in accordance with the distribution ratios decided.
